(19) United States
(12) Patent Application Publication
(10) Pub. No.: US 2020/0306813 A1
(43) Pub. Date: Oct. 1, 2020

(54) SHEET CUTTING AND BENDING APPARATUS

(71) Applicant: KUO-CHUNG CHENG, New Taipei City (TW)

(72) Inventor: KUO-CHUNG CHENG, New Taipei City (TW)

(21) Appl. No.: 16/794,205

(22) Filed: Feb. 18, 2020

(30) Foreign Application Priority Data
Mar. 25, 2019 (TW) 108203560

(51) Int. Cl. B21D 28/26; B23D 15/00; B23D 29/02; B26D 1/30; B26D 5/10

(52) U.S. Cl. CPC B21D 28/26; B23D 15/002; B26D 5/10; B26D 1/30; B23D 29/026

(57) ABSTRACT

A sheet cutting and bending apparatus for cutting a wavy sheet and forming trapezoidal notches required for installation includes a base, two cutters at an end of the base, and a force applying mechanism for driving the two cutters. A knife of the cutters has no handle but just has a curved force receiving edge at the rear edge. The force applying mechanism has two rocker aims driven by a rocker rod and a force applying rod bridging between the two rocker arms for abutting a force receiving edge of the knife to produce a shear force and pushing the knife efficiently to cut two incisions at an edge of the sheet. In addition, a bending mechanism is linked with the force applying mechanism and provided for flipping a plate between the two incisions inwardly to form trapezoidal notches required for installation at the edge of the sheet.

### BACKGROUND OF THE INVENTION

### Field of the Invention

The present invention relates to a sheet cutting and bending apparatus, in particular to the sheet cutting and bending apparatus for cutting wavy or other sheets, and the apparatus is capable of cutting an edge of the sheet and bending the sheet to form trapezoidal notches required for installation.

### Description of Related Art

In general, present wavy sheets such as steel sheets with a continuous trapezoidal cross-section can be used for constructing roofs, canopies, or sidewalls, etc. Since the wavy sheets are continuous trapezoidal sheet, a large gap will be formed when an end of the wavy sheet is attached to a wall, or a very large gap will be formed when a mountain roof is constructed. Therefore, it is necessary to wrap or cover the connected ends of the wavy sheets by edge plates and fill the gaps with silicone. However, when the plate is combined with the wavy sheets, it is necessary to cut the edges to form trapezoidal notches, so that the trapezoidal notches can be sheathed on the trapezoidal plate of the wavy sheets before the edge-finishing process is completed.

During the process of cutting the edge of the sheet to form the trapezoidal notches, technicians need to cut beautiful and neat trapezoidal notches by using a pair of cutters, and such method of using cutters for cutting is quite physically exhausted, and the construction work is slow.

### SUMMARY OF THE INVENTION

In view of the aforementioned drawbacks of the prior art, the inventor of the present invention based on years of experience in the related industry to conduct extensive research and experiment, and finally developed a sheet cutting and bending apparatus in hope of achieving the effects of cutting and bending a sheet more efficiently, expediting the construction, and providing a convenient operation.

To achieve the aforementioned and other objectives, the present invention provides a sheet cutting and bending apparatus, for cutting an edge of a wavy sheet or any other sheet while bending the sheet, so that trapezoidal notches required for installation can be formed at an edge of the sheet (such as the wavy sheet) to achieve the effects of efficient sheet cutting and bending, quick construction, and convenient operation.

To achieve the aforementioned and other objectives, the present invention provides a sheet cutting and bending apparatus, for cutting and bending a sheet such as a wavy sheet, and the apparatus preferably comprises: a base, having two pivot mounts disposed on the top of a first end of the base; two cutters, symmetrically installed on both sides of the first end of the base, and each of the cutters having a first knife and a second knife protruding out from the first end of the base; a fixing portion being formed at a rear end of the first knife and fixed to the base; the second knife being rotatably and pivotally coupled to a rear edge of the first knife and the second knife to form a force receiving edge; a force applying mechanism, having a rotating shaft, rotatably and horizontally installed between the two pivot mounts; a rocker rod with an end combined with the rotating shaft for rocking the rotating shaft to rotate; two rocker arms, combined with both ends of the rotating shaft, and driven by the rotating shaft to rock an end of the rotating shaft to move up and down; and a force applying rod, bridging between the two rocker arms, and having a rod body and abutting at the force receiving edge of the second knife, and the force applying rod rocking up and down to push a blade of the second knife and a blade of the first knife to be engaged or disengaged with each other; and a bending mechanism, installed at the top of the first end of the base, and having a sheet bending member linked and driven by the force applying mechanism.

In the sheet cutting and bending apparatus, the force receiving edge of the second knife is a curved edge facing downward, and the force applying rod abuts the curved edge.

In the sheet cutting and bending apparatus, the cutter has a first elastic element for driving the blade of the second knife to separate from the blade of the first knife.

In the sheet cutting and bending apparatus, the first elastic element is a tension spring coupled between the base and the second knife.

In the sheet cutting and bending apparatus, the two pivot mounts have a bearing, and both ends of the rotating shaft pass through the bearing.

In the sheet cutting and bending apparatus, the bending mechanism comprises: a socket rotatably sheathed on the rotating shaft; a first link lever, with an end fixed to the socket; a second link lever, having an end pivotally coupled to the first link lever, and the other end pivotally coupled to a first pivoting position of the sheet bending member; a third link lever, having an end pivotally coupled to a second pivoting position of the sheet bending member and the other end pivotally coupled to a pivoting portion of the base, and the third link lever further having a lug abutting a rod body of the force applying rod.

In the sheet cutting and bending apparatus, the socket has a strip groove communicating to the interior of the socket and extends a perimeter along the circumference of the socket, and an end of the rocker rod passes through the strip groove to combine with the rotating shaft.

In the sheet cutting and bending apparatus, the sheet bending member is a bar, and an end of the sheet bending member has the first pivoting position and the second pivoting position separately, and the other end of the sheet bending member can be flipped up to bend the sheet.

In the sheet cutting and bending apparatus, the bending mechanism has a second elastic element for driving the sheet bending member to restore its original position.

The sheet cutting and bending apparatus of the present invention may apply the base to be put on the trapezoidal wavy sheet, so that the blades of the two cutters hold the edge of a sheet (such as another wavy sheet), and a user may operate the rocker rod of the force applying mechanism to drive the rocker arm and the force applying rod to swing upward, and the force applying rod pushes the second knife to cut two incisions from the wavy sheet, and then the rocker rod is operated to drive the bending mechanism, so that the other end of the sheet bending member is flipped upwardly to bend the plate between the incisions, and the trapezoidal notches required for installation of other wavy sheets can be formed, so as to achieve the effects of efficient sheet cutting and bending, quick construction , and convenient operation.

### BRIEF DESCRIPTION OF THE DRAWINGS

FIG. 1 is a perspective view showing a using status of a sheet cutting and bending apparatus in accordance with a preferred embodiment of the present invention;

FIG. 2 is a perspective front view of a sheet cutting and bending apparatus in accordance with a preferred embodiment of the present invention;

FIG. 3 is a perspective rear view of a sheet cutting and bending apparatus in accordance with a preferred embodiment of the present invention;

FIG. 4 is a top view of a sheet cutting and bending apparatus in accordance with a preferred embodiment of the present invention;

FIG. 5 is a longitudinally cross-sectional view of a sheet cutting and bending apparatus in accordance with a preferred embodiment of the present invention;

FIG. 6 is a schematic view of a cutting operation of a sheet cutting and bending apparatus in accordance with a preferred embodiment of the present invention; and

FIG. 7 is a schematic view of a bending operation of a sheet cutting and bending apparatus in accordance with a preferred embodiment of the present invention.

### DESCRIPTION OF THE INVENTION

The aforementioned and other objects, characteristics and advantages of the present invention will become apparent with the detailed description of the preferred embodiments and the illustration of related drawings as follows.

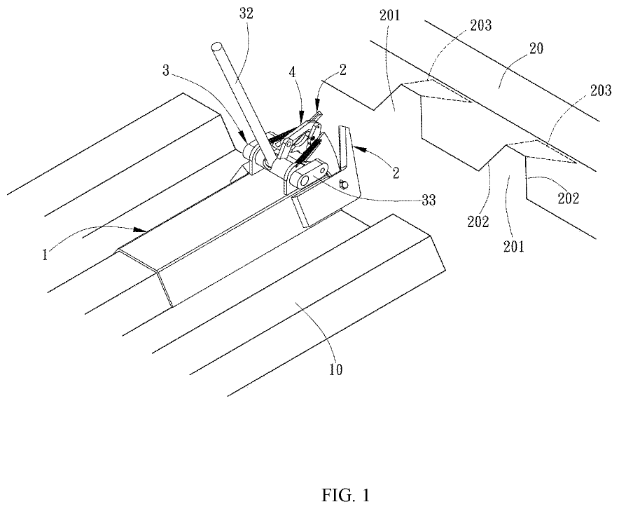

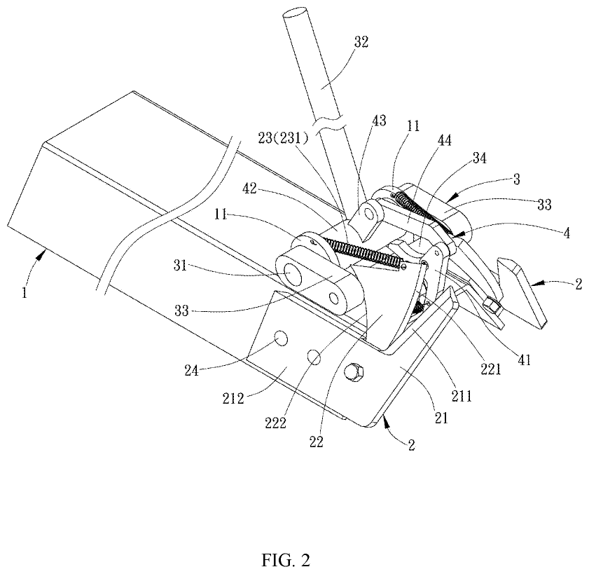

In FIG. 1, a sheet cutting and bending apparatus of the present invention is put on a wavy sheet 10 and used to cutting another wavy sheet 10 or another sheet 20 and form trapezoidal notches 201 required for installing the wavy sheet 10. With reference to FIGS. 2, 3, 4 and 5 for a sheet cutting and bending apparatus in accordance with a preferred embodiment of the present invention, the sheet cutting and bending apparatus comprises a base 1, two cutters 2, a force applying mechanism 3 and a bending mechanism 4.

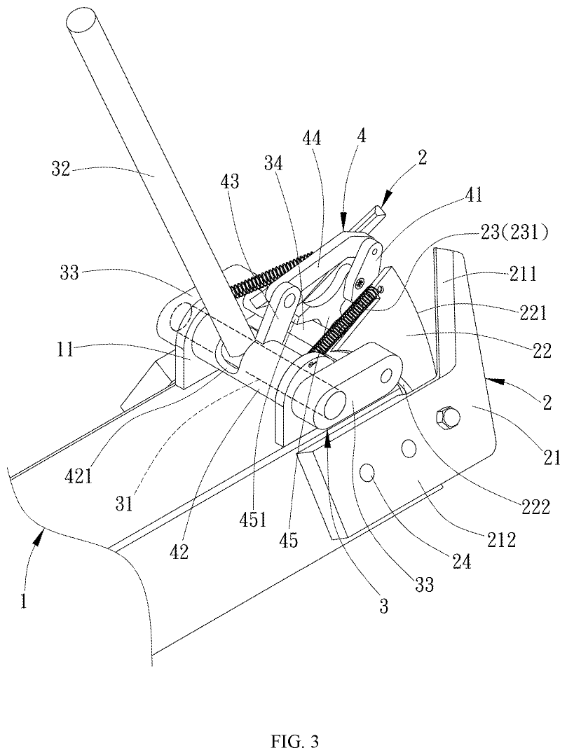

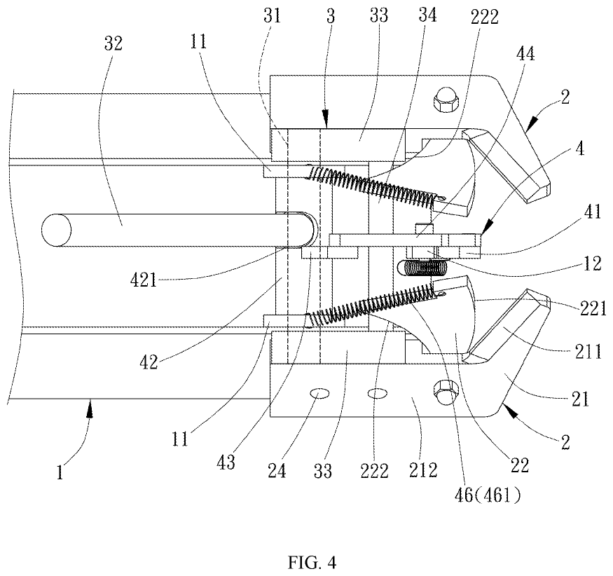

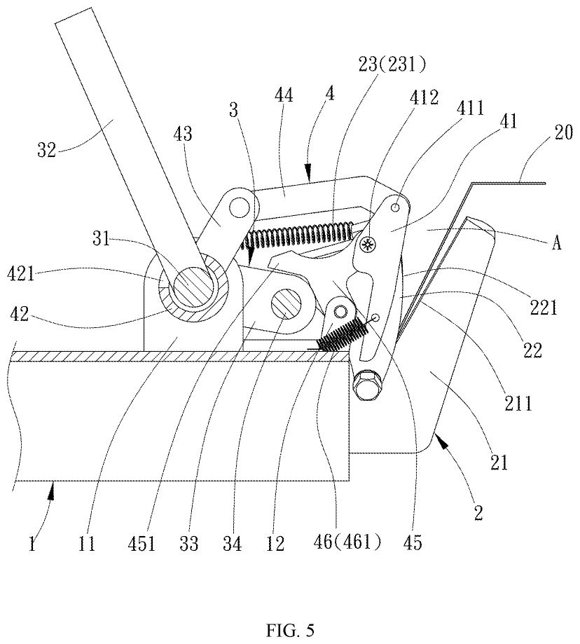

In FIGS. 2 and 3, the base 1 is in form of a tapered trapezoidal assembly, an n-shaped assembly, or other shaped assembly and formed by bending a metal sheet, and the base 1 is preferably a trapezoidal assembly with a size corresponding to a general wavy sheet and it can be used for quickly sheathing wavy sheets 10 with a trapezoidal cross-section (as shown in FIG. 1). Two symmetrical pivot mounts 11 are disposed at the top of the first end of the base 1, and each of the two pivot mounts 11 has a bearing, and a pivoting portion 12 is disposed at the middle of the top of the first end of the base 1 first end (as shown in FIGS. 4 and 5), and the two pivot mounts 11 and the pivoting portion 12 are used for assembling the following components.

With reference to FIGS. 3, 5 and 6, the two cutters 2 are symmetrically installed on both sides of the first end of the base 1, and each of the cutters 2 has a first knife 21 and a second knife 22 protruding from the first end of the base 1; the first knife 21 is an L-shape assembly with a blade 211 at the front end and a fixing portion 212 at the rear end, and the fixing portion 212 and a plurality of fixing elements 24 are provided for fixing the first knife 21 to a side of the base 1; a lower end of the second knife 22 is rotatably and pivotally coupled to an inner side of the first knife 21, and the second knife 22 has a convex curved blade 221 formed at a front edge of the second knife 22 and a concave curved force receiving edge 222 formed at a rear edge of the second knife 22, so that when a force is applied to the force receiving edge 222, the second knife 22 is push to engage/disengage the second knife 22 to/from the first knife 21. In a preferred embodiment, the force receiving edge 222 of the second knife 11 is a curved edge facing down towards the rear side. In addition, each of the cutters 2 has a first elastic element 23 for driving a blade of the second knife 22 to separate from a blade of the first knife 21. In a preferred embodiment, the first elastic element 23 is a tension spring 231 coupled between a pivot mount 11 (or another position) of the base 1 and the second knife 22, so that the blades of the cutters 2 can be spread open.

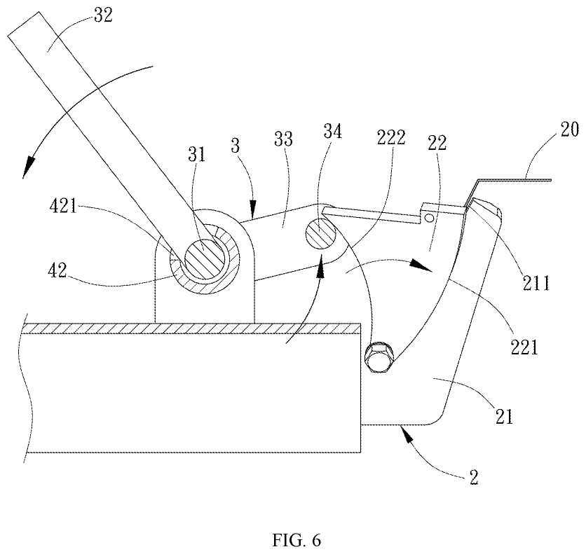

With reference to FIGS. 3, 4 and 5, the force applying mechanism 3 preferably comprises a rotating shaft 31 rotatably and horizontally installed between the two pivot mounts 11, so that both ends of the rotating shaft 31 pass through bearings of the two pivot mounts 11; a rocker rod 32, with an end combined with the top of the middle near the rotating shaft 31, and provided for a user to grip and hold in order to shake the rotating shaft 31 to rotate; two rocker arms 33, combined with both ends of the rotating shaft 21 and disposed on outer sides of the two pivot mounts 11 respectively, so that the two rocker arms 33 can be driven by the rotating shaft 31 and an end (or a front end) of the rocker arm 33 swings up and down; and a force applying rod 34, bridging between the front ends of the two rocker arms 33, and the top of the rod body of the force applying rod 34 abutting a curved edge of the force receiving edge 222 of the second knife 22 when rising (as shown in FIG. 6) to push the second knife 22 to move near the first knife 21, so that the up and down shaking of the force applying rod 34 can push the blade 221 of the second knife 22 to engage/disengage the blade 211 of the first knife 21.

In FIGS. 2 to 5, the bending mechanism 4 is installed to the top of the first end of the base 1 and comprises a sheet bending member 41 that can be driven by the force applying mechanism 3; the bending mechanism 4 of a preferred embodiment comprises: a socket 42, rotatably sheathed on the rotating shaft 31 of the force applying mechanism 3, and having a strip groove 421 communicating with the interior of the socket 42, and the strip groove 421 extending a perimeter along the circumference of the socket 42, and an end of the rocker rod 32 is passed through the strip groove 421 to combine with the rotating shaft 31; a first link lever 43, having an end fixed to the socket 42; a second link lever 44, having an end pivotally coupled to the first link lever 43 and the other end pivotally coupled to the first pivoting position 411 of the sheet bending member 41; a third link lever 45 having an end pivotally coupled to the second pivoting position 412 of the sheet bending member 41 and the other end pivotally coupled to the pivoting portion 12 of the base 1, and a lug 451 disposed at a rear edge of the third link lever 45, and a lower edge of the lug 451 abutting a rod body of the force applying rod 34.

In a preferred embodiment as shown in FIG. 5, the sheet bending member 41 is a bar, and an end of the sheet bending member 41 has the first pivoting position 411 and the second pivoting position 412, and the other end of the sheet bending member 41 may be flipped upwardly for bending the sheet. In addition, the bending mechanism 4 has a second elastic element 46 provided for driving the sheet bending member 41 to restore its original position, and the second elastic element 46 is preferably a tension spring 461 coupled between the sheet bending member 41 and the base 1.

With reference to FIG. 5 for an application of the sheet cutting and bending apparatus of the present invention, the sheet cutting and bending apparatus is moved to a position such that blades gap A between the two cutters 2 is engaged with an edge of a sheet 20. In FIG. 6, a user turns the rocker rod 32 of the force applying mechanism 3 backward, so that the rocker rod 32 synchronously drives the rotating shaft 31, the two rocker arms 33 and the force applying rod 34 to swing upward, and the force applying rod 34 abuts the force receiving edge 222 of the second knife 22 upwardly to push the second knife 22, so as to close the blades gap A of the second knife 22 and the first knife 21 and allows the sheet edge to be cut into two incisions 202 (as shown in FIG. 1).

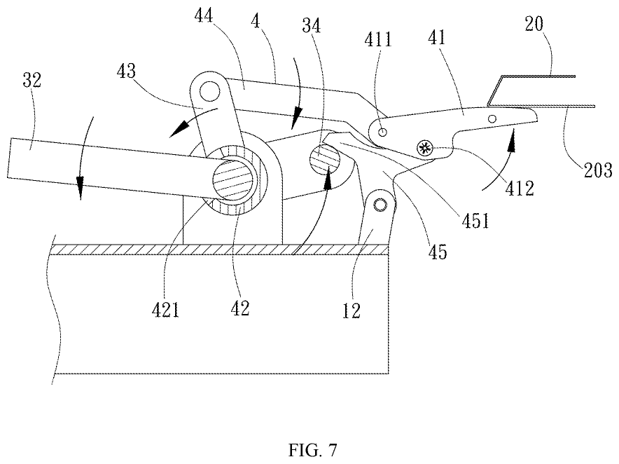

In FIG. 1, when it is necessary to bend the plate 203 between two incisions 202 inwardly, the rocker rod 32 is operated and turned backward as shown in FIG. 7, so that the rocker rod 32 abuts a rear end of the strip groove 421 of the socket 42 to drive the socket 42 and the first link lever 43 to turn backward, while the first link lever 43 is driving the second link lever 44 to turn downward, and the two rocker arms 33 and the force applying rod 34 continue swing upward, so that the force applying rod 34 props the lower edge of the lug 451 of the third link lever 45 to turn the third link lever 45 to move forward. With the operating principle of the four link levers of the bending mechanism 4, the sheet bending member 41 is flipped upward to push the plate between the two incisions 202 to bend inward (as shown in FIGS. 1 and 7), so that the required trapezoidal notches 201 are formed on the sheet 20.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A sheet cutting and bending apparatus, for cutting and bending a sheet, comprising:
a base, having two pivot mounts disposed on the top of a first end of the base;
two cutters, symmetrically installed on both sides of the first end of the base, and each of the cutters having a first knife and a second knife protruding out from the first end of the base; a fixing portion being formed at a rear end of the first knife and fixed to the base; the second knife being rotatably and pivotally coupled to a rear edge of the first knife and the second knife to form a force receiving edge;
a force applying mechanism, having a rotating shaft, rotatably and horizontally installed between the two pivot mounts; a rocker rod with an end combined with the rotating shaft for rocking the rotating shaft to rotate; two rocker arms, combined with both ends of the rotating shaft, and driven by the rotating shaft to rock an end of the rotating shaft to move up and down; and a force applying rod, bridging between the two rocker arms, and having a rod body and abutting at the force receiving edge of the second knife, and the force applying rod rocking up and down to push a blade of the second knife and a blade of the first knife to be engaged or disengaged with each other; and
a bending mechanism, installed at the top of the first end of the base, and having a sheet bending member linked and driven by the force applying mechanism.

2. The sheet cutting and bending apparatus of claim 1, wherein the force receiving edge of the second knife is a curved edge facing downward, and the force applying rod abuts the curved edge.

3. The sheet cutting and bending apparatus of claim 1, wherein the cutter has a first elastic element for driving the blade of the second knife to separate from the blade of the first knife.

4. The sheet cutting and bending apparatus of claim 3, wherein the first elastic element is a tension spring coupled between the base and the second knife.

5. The sheet cutting and bending apparatus of claim 1, wherein the two pivot mounts have a bearing, and both ends of the rotating shaft pass through the bearing.

6. The sheet cutting and bending apparatus of claim 1, wherein the bending mechanism comprises: a socket rotatably sheathed on the rotating shaft; a first link lever, with an end fixed to the socket; a second link lever, having an end pivotally coupled to the first link lever, and the other end pivotally coupled to a first pivoting position of the sheet bending member; a third link lever, having an end pivotally coupled to a second pivoting position of the sheet bending member and the other end pivotally coupled to a pivoting portion of the base, and the third link lever further having a lug abutting a rod body of the force applying rod.

7. The sheet cutting and bending apparatus of claim 6, wherein the socket has a strip groove communicating to the interior of the socket and extends a perimeter along the circumference of the socket, and an end of the rocker rod passes through the strip groove to combine with the rotating shaft.

8. The sheet cutting and bending apparatus of claim 6, wherein the sheet bending member is a bar, and an end of the sheet bending member has the first pivoting position and the second pivoting position separately, and the other end of the sheet bending member can be flipped up to bend the sheet.

9. The sheet cutting and bending apparatus of claim 8, wherein the bending mechanism has a second elastic element for driving the sheet bending member to restore its original position.
